(19) United States
(12) Patent Application Publication
(10) Pub. No.: US 2024/0383703 A1
(43) Pub. Date: Nov. 21, 2024

(54) MEDIA LOADING

(71) Applicant: Hewlett-Packard Development Company, L.P., Spring, TX (US)

(72) Inventors: Joseba ORMAECHEA SARACIBAR, Sant Cugat del Valles (ES); Eduardo MARTIN ORUE, Sant Cugat del Valles (ES); Jordi ALBERT GINE, Sant Cugat del Valles (ES); German ORTEGA DE MINGO, Sant Cugat del Valles (ES); Rafael ULACIA PORTOLES, Sant Cugat del Valles (ES); Marc BENAZET BLANES, Sant Cugat del Valles (ES); Felix RUIZ MARTINEZ, Sant Cugat del Valles (ES); Javier ONECHA CELESTINO, Sant Cugat del Valles (ES)

(73) Assignee: Hewlett-Packard Development Company, L.P., Spring, TX (US)

(21) Appl. No.: 18/690,645

(22) PCT Filed: Sep. 10, 2021
(86) PCT No.: PCT/US2021/049882

§ 371 Date: Mar. 8, 2024

(51) Int. Cl. B65H 5/06; B65H 5/36

(52) U.S. Cl. CPC B65H 5/068; B65H 5/36; B65H 2404/152

(57) ABSTRACT

According to an example, a roller assembly for media loading comprises a fixed frame, a plurality of parallel rollers that protrude from a bottom surface of the fixed frame, and a coupling member to mechanically coupled the fixed frame to a reference surface, wherein each roller of the plurality of rollers is rotatably coupled to the fixed frame and is movable with respect to the bottom surface of the fixed frame.

### BACKGROUND

Media loading systems are used to perform loading operations on printing systems. In some examples, a media loading system may be in the form of a standalone system to be operatively connected to the printing system. In use, the media loading systems transport media from an input region to an output region.

### BRIEF DESCRIPTION OF DRAWINGS

Features of the present disclosure are illustrated by way of example and are not limited in the following figure(s), in which like numerals indicate like elements, in which:

FIG. 1 shows a top view of a roller assembly, according to an example;

FIG. 2 shows a cross-sectional view of a roller assembly mechanically coupled to a reference surface, according to an example;

FIG. 3A shows a side view of roller assembly in which rollers contact an upper surface of a medium moving through a gap between the roller assembly and a target surface, according to an example;

FIG. 3B shows the roller assembly of FIG. 3A when the medium is in a second position;

FIG. 4 shows a side view of a roller assembly comprising guiding tracks to enable movement of the rollers with respect to a target surface, according to an example;

FIG. 5 shows a side view of a roller assembly comprising pivoting arms rotatably coupled to the rollers, according to an example;

FIG. 6 shows a side view of a roller assembly comprising pivoting arms rotatably coupled to the idle rollers, according to an example;

FIG. 7 shows a top view of a roller assembly comprising a locking member to lock idle rollers in an upper position, according to an example;

FIG. 8 shows a media loading system comprising a roller assembly, according to an example;

FIG. 9 shows a media loading system comprising a roller assembly in a non-operative position, according to an example.

### DETAILED DESCRIPTION

For simplicity and illustrative purposes, the present disclosure is described by referring mainly to examples. In the following description, numerous specific details are set forth to provide a thorough understanding of the present disclosure. It will be readily apparent, however, that the present disclosure may be practiced without limitation to these specific details. In other instances, some methods and structures have not been described in detail so as not to unnecessarily obscure the present disclosure.

Throughout the present disclosure, the terms “a” and “an” are intended to denote at least one of a particular element. As used herein, the term “includes” means includes but not limited to, the term “including” means including but not limited to. The term “based on” means based at least in part on.

Media loading systems are used to load media on printing systems. In use, a media loading system transports a medium loaded in an input region towards an output region of the media loading system. To transport the medium, the media loading system may comprise a conveyor to exert a force to the medium such that the medium is moved. Examples of conveyors comprise conveyor belts, rolling members, vacuum-based systems, among others.

When performing media loading operations, sheets of media are received in an input region of the media loading system. In an example, the input region may correspond with a media tray where sheets of print media are stacked. In other examples, the input region may correspond with an input slot where sheets of media are manually inserted by the user of the media loading system. In some other examples, the media loading system may be connected to a feeding member such that the sheets of media are automatically inserted into the media loading system by the feeding member. Then, upon receiving the medium in the input region, the media loading system will convey the media towards the output region. In some examples, to increase the throughput of the media loading system, a medium may be transported towards the output region at a speed within a speed range from 0.05 m/s (around 2 ips) to 0.381 m/s (around 15 ips).

In an example, the media loaded in the input region of the media loading system may be skewed. Hence, the movement of the media towards the output region may result in contact of the media with lateral guides of the media loading systems which may result in media buckling. As a result of the media buckling, the throughput of the loading operation may be decreased, the media may be damaged, other components belonging to the media loading system or systems located downstream the media loading system may be damaged, among others.

To control unpredictable media buckling when performing media loading operations, users may opt for relying on sensors to ensure that the loaded medium is not skewed. However, these solutions may increase the overall cost for the media loading system (for instance, cost associated with the addition of the additional sensors or the increase of idle times associated with the decrease of the media loading system throughput). In other examples, the medium may be guided towards a lateral guide of a media loading system to re-align it, therefore, even though the sensors detect that the medium is not skewed in the input region of the media loading system, the medium may experience media buckling when contacting the lateral guide of the media loading system due to such media alignment assurance process performed on the media.

Disclosed herein are examples of media loading mechanisms, media loading systems, and roller assemblies that may be used to control media buckling which may occur during media loading operations carried out by a media loading system. Hence, different examples of devices and systems are described.

As used herein, the term “media buckling” will be used to refer to events experienced by the medium in which a portion of the medium is bent, crumpled, or wrinkled. In turn, experiencing media buckling may result in further unintentional events such as media jam which may have a negative impact on the media loading operation. In addition, as used herein, the term “media” will be used to refer to any media which may be printed on. Examples of media include paper, cardboard, wood, tin, and/or metal.

Media may experience media buckling when the forces received by a medium exceed a critical buckling force. In an example, the critical buckling force may be a function of at least one of the mechanical properties of the medium (for instance, an elastic modulus of the medium), the dimensions of the medium (for instance, the base and the height in which the medium experiences the smallest moment of inertia), the unsupported length of the medium (i.e., the clear distance between a member capable of providing lateral support to the medium and an edge of the medium supported by a supporting member), and a weighting factor which may depend on the condition of end support between the medium and the supporting member(s) (for instance, a first factor associated with one fixed end and one free end, a second factor associated with two fixed ends, or a third factor associated with two free ends).

On the other hand, the forces received by the medium may comprise the forces received from an external element(s). In an example, when contacting the medium with rollers, the forces may comprise the frictional forces and the forces associated with a rotation of the rollers (if a motor transmits torque to the rollers). In particular, the frictional forces may be based on the friction coefficient between the rollers and the medium and the overall force exerted by the rollers to the medium. Therefore, if the overall received forces exceed the critical buckling force, the medium will experience media buckling. In other examples, when using idle rolling elements, the forces received by the medium may comprise the frictional forces that result from the contact (i.e., the rolling elements are not actively rotated to transmit further forces to the medium and therefore the rolling elements do not transfer additional forces to the medium).

Hence, to mitigate unpredictable media buckling, media buckling prevention mechanisms and media loading systems may be designed to increase the critical buckling force, to decrease the forces received by the medium, or a combination thereof.

In an example, a media buckling prevention mechanism may be used to prevent media loading operations from media buckling. Due to the media buckling appearance depends on the forces received by the medium, the media buckling prevention mechanism may aim to keep the forces received by the medium below the critical buckling force. In an example, an event that may cause the medium to buckle is a contact with a lateral guide of a media loading system. In some examples, the medium may be guided towards the lateral guide of the media loading on purpose to re-align the medium while moving the medium towards the output region. However, in other examples, the medium may be tilted towards the lateral guide and as a result of the movement may contact the lateral guide of the media loading system.

In some examples, a media loading buckling prevention mechanism may comprise an upper frame at a distance above a target surface, and a plurality of rolling elements to contact an upper surface of a medium to be moved over the target surface. To enable contact between the rolling elements and the medium, the rolling elements protrude from a bottom surface of the upper frame. Furthermore, to enable a range of media thicknesses, the plurality of rolling elements is movable to contact the upper surface of the medium, wherein the plurality of rolling elements is biased towards the medium so that a contact of a rolling element with the upper surface of the medium pushes the rolling element towards the upper frame.

In some examples, the upper frame extends along a length of a reference surface. The reference surface may correspond, for instance, with a lateral guide of the media loading system. As a result, unpredictable media buckling generated after contact between an edge of the medium and the lateral guide will be mitigated.

As explained above, some of the factors which may impact the critical buckling force depend on the medium being loaded and the relationship between the loaded medium and external elements (for instance, the unsupported length of the medium). In some examples, the critical buckling force can be increased by modifying one of the factors that define the critical buckling force. However, due to some of the factors are intrinsically linked to the medium, the increase of the critical buckling force may be obtained by modifying at least one of the factors related to external elements. In an example, the critical buckling force increases as the unsupported length of the medium decreases. To decrease the unsupported length, the elements used to contact the medium (for instance, a plurality of rollers of a media buckling prevention mechanism) may be positioned as close as possible to an edge of the medium. In an example, when having available the reference surface, the elements used to contact the medium may be positioned adjacent to the reference surface. Hence, when the medium contacts the reference surface, the contact between the elements used to contact the medium and the medium will prevent the media from buckling. On the other hand, as explained above, an alternative (or complementary) action to reduce the chances of experiencing media buckling may be to decrease the forces received by the medium (for instance, the frictional forces generated during contact) and the relative position between the elements used to contact the medium and the reference surface. In an example, to decrease the frictional forces, the overall weight of the elements used to contact the medium may be reduced (for instance, when using a plurality of rollers, keeping some of the rollers away from the medium).

In some examples, a media loading buckling prevention mechanism may comprise a locking member to selectively lock at least one of the rolling elements in a position away from the medium such that an overall force exerted towards the upper surface of the medium is reduced. In this fashion, a range of admissible media thicknesses for the media loading buckling prevention mechanism will be increased while avoiding the appearance of media buckling.

In some other examples, the plurality of rolling elements of the media loading buckling prevention mechanism may fail to exert a desired force towards the medium. As a result, contact between the rolling elements and the medium may result in slippage that may lead to media buckling. To ensure proper contact between the rolling elements and the medium, in some examples, the upper frame of the media loading buckling prevention mechanism may comprise biasing members to bias the rolling elements towards the upper surface of the medium such that an overall force exerted towards the upper surface of the medium is increased. However, on the other hand, as the forces transmitted to the medium increase to ensure proper contact between the rolling elements and the medium, a range of admissible media thicknesses for the media loading buckling prevention mechanism decreases.

According to an example, a roller assembly may comprise a plurality of parallel rollers to contact an upper surface of a medium so as to increase the critical buckling force. Among others, the roller assembly may increase the critical buckling force by reducing an unsupported length of the medium. In addition, to enable multiple media thicknesses, the plurality of parallel rollers may be movable with respect to a medium moving over a target surface.

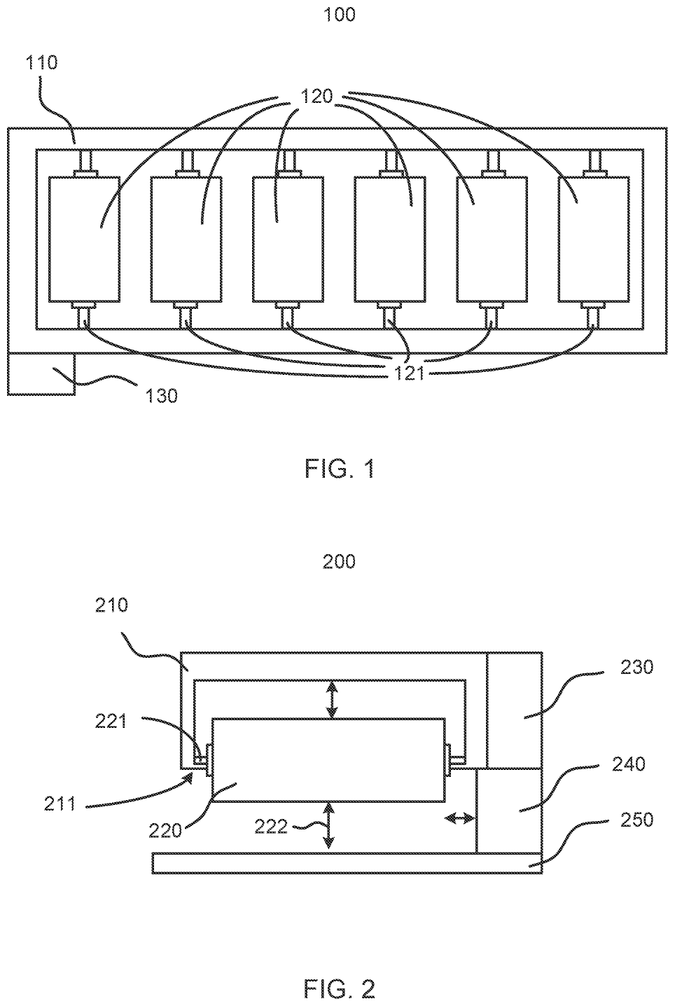

Referring now to FIG. 1, a top view of a roller assembly 100 for media loading is shown. In use, the roller assembly 100 may be used to prevent a media loading operation from media buckling. The roller assembly 100 comprises a fixed frame 110, a plurality of parallel idle rollers 120, and a coupling member 130 to mechanically couple the fixed frame 110 to a reference surface (not shown in FIG. 1). In an example, the reference surface may be a lateral guide of a media loading system.

To couple the plurality of parallel rollers 120 to the fixed frame 110, each roller is rotatably coupled to the fixed frame 110 via a respective pin of a plurality of pins 121. Furthermore, to avoid media buckling in media having a range of thicknesses, the plurality of parallel rollers 120 is movable with respect to the bottom surface of the fixed frame 110.

In some examples, the plurality of parallel rollers 120 of the roller assembly 100 may be distributed along a media path direction of the medium such that the forces transmitted to the medium are parallel to the media path direction. In other examples, the plurality of parallel rollers 120 of the roller assembly 100 may be perpendicular to a reference surface on which the roller assembly is mechanically connected via the coupling member 130. In an example, the plurality of parallel rollers 120 of the roller assembly 100 is positioned as close as possible to the reference surface such that an unsupported length of the medium is reduced (thereby increasing the critical buckling force). In some other examples, to effectively reduce the appearance of media buckling, the plurality of parallel rollers is distributed in a single line of rollers along the length of the reference surface.

Referring now to FIG. 2, a cross-sectional view of a roller assembly 200 coupled to a reference surface 240 is shown. The roller assembly 200 comprises a fixed frame 210, a plurality of parallel rollers 220 protruding from a bottom surface 211 of the fixed frame 210, and a coupling member 230 mechanically coupling the fixed frame 210 to the reference surface 240. As previously explained, the plurality of parallel rollers 220 is rotatably coupled to the fixed frame 210 via a plurality of pins 221.

In FIG. 2, the plurality of parallel rollers 220 is represented in a lower position in which the plurality of parallel rollers 220 is at a distance 222 above a target surface 250. To enable a distance range associated with a range of media thicknesses, the plurality of pins 221 is movable. In FIG. 2, the plurality of pins 221 is movable within an inner volume of the fixed frame 210. In this fashion, a medium moving beneath the fixed frame 210 will contact a roller of the plurality of parallel rollers 220 if the thickness of the medium is greater than the distance 222. In addition, to increase the critical buckling force, the plurality of parallel rollers 220 is positioned adjacent to the reference surface 240.

In an example, the plurality of parallel rollers 220 is movable with respect to the bottom surface 211 of the fixed frame 210 within a distance range from 1 mm to 9 mm. However, in other examples, the ranges may include an offset to compensate the relative location between the fixed bottom surface 211 of the fixed frame 210 and the target surface 250 (for instance, a distance range from 11 mm to 19 mm). In an example, the distance range from 1 mm to 9 mm enables the plurality of rollers 220 to contact media having a thickness within a thickness range from 0.1 mm to 4 mm. In some other examples, the distance range enables a thickness within a thickness range from 0.1 mm to 2 mm.

In some examples, the coupling member 230 may comprise a hinge to enable a rotation of the fixed frame 210 with respect to the reference surface 240. As a result, the roller assembly 200 may be movable between an operative position in which the plurality of parallel rollers 220 faces the target surface 250 and a non-operative position in which the plurality of parallel rollers 220 is away from the target surface 250.

Although in the rolling assembly 200 represented in FIG. 2 the plurality of rollers 220 is represented at the distance 222 above the target surface 250, in other examples, a lower position of the plurality of rollers 220 corresponds to a position in which the plurality of rollers 220 is in contact with the target surface 250 (i.e., the distance 222 is substantially zero).

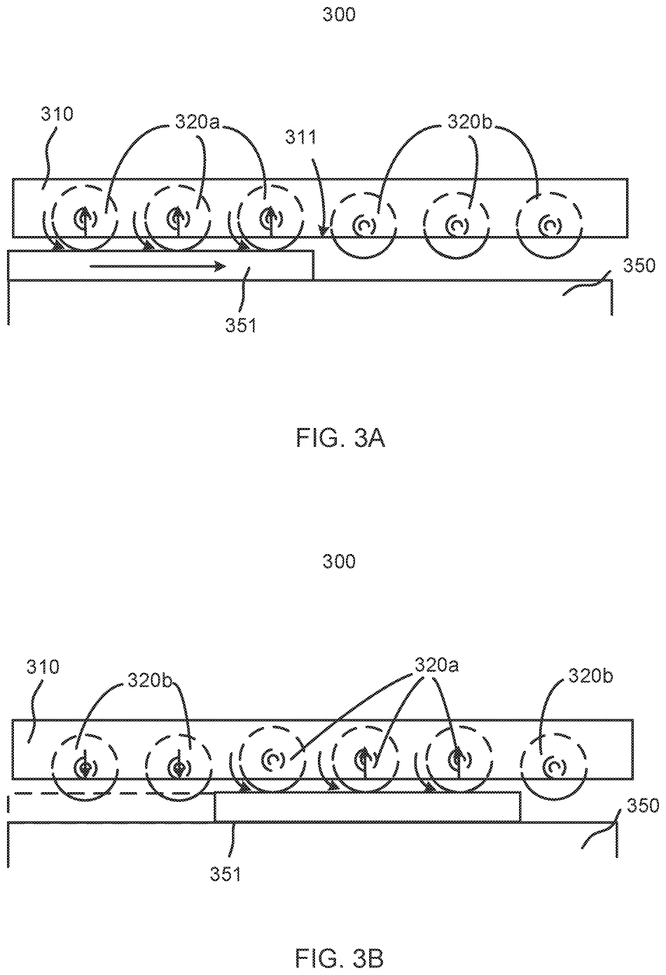

Referring now to FIG. 3A, a side view of roller assembly 300 and a medium 351 in a first position is shown. The roller assembly 300 comprises a fixed frame 310, a plurality of rollers protruding from a bottom surface 311 of the fixed frame 310, and a coupling member (not shown in FIG. 3) to couple the fixed frame 310 to a reference surface. In the first position, the medium 351 moves through a gap defined between the fixed frame 310 and a target surface 350. During the movement, the rollers protruding from the bottom surface 311 of the fixed frame 310 contact the upper surface of the medium 351.

In FIG. 3A, the plurality of rollers comprises a first group of rollers 320a in contact with the upper surface of the medium 351 and a second group of rollers 320b not contacting the medium 351. Since the thickness of the medium 351 is greater than the distance between the first group of rollers 320a and the target surface 350, in the first position represented in FIG. 3A the contact results in a movement of the first group of rollers 320a towards the fixed frame 310. In addition, due to rollers of the first group of rollers 320a are idle rollers, the contact causes the first group of roller 320a to rotate in a counterclockwise direction. On the other hand, the second group of rollers 320b rests in a lowermost position. As described above, a distance range of the plurality of rollers defined from an uppermost position and the lowermost position may be set so as to enable a wide range of media thicknesses associated with the distance range.

In some examples, the lowermost position may correspond to a position in which the rollers contact the target surface 350. In some other examples, the target surface 350 may comprise a conveyor to transport the medium 351 and the rollers in the lowermost position are in contact with the conveyor. Then, as a result of the contact, the rollers will rotate in a counterclockwise direction even though the rollers are not in contact with the medium. In this fashion, upon the medium contacts the rollers in the lowermost position, the rollers transmit traction to the medium as the rollers are moving upwards. Due to the frictional forces oppose motion, the traction transmitted to the medium will reduce the overall forces received by the medium.

Referring now to FIG. 3B, a side view of the roller assembly 300 of FIG. 3A and the medium 351 in a second position is shown. In the second position, the medium 351 has advanced through the gap defined between the fixed frame 310 of the roller assembly 300 and the target surface 350 on which the medium 351 is disposed. In an example, the target surface 350 may comprise a conveyor to move the medium 351 to the second position.

As a result of the movement from the first position (represented in FIG. 3A) to the second position (represented in FIG. 3B), the first roller and the second roller of the roller assembly 300 have moved downwards (i.e., have moved away from the bottom surface 311 of the fixed frame 310). In other words, the first roller and the second roller have changed from the first group of rollers 320a which contact the upper surface of the medium 351 to the second group of rollers 320b which does not contact the upper surface of the medium 351. Also, in the second position, the fourth roller and the fifth roller have moved upwards as a result of contact of the medium 351 and the rollers (i.e., the fourth roller and the fifth roller have changed from the second group of rollers 320b to the first group of rollers 320a).

According to some examples, each of the rollers of the plurality of rollers is to exert to the medium a force within a range from 0.8 N to 1.2 N. In an example, the weight of each roller may be selected in accordance with the force (for instance, a weight within a range from 80 grams to 120 grams). However, as previously explained, in other examples the weight of the rollers may be supplemented by a force exerted by a biasing member biasing the roller towards the medium. In this fashion, the appearance factors such as the media slippage may be prevented while avoiding the media buckling in for media having a thickness within a range of thicknesses. In addition, when selecting a weight for the rollers (or supplementing the weight using biasing members) the range of distances defined by the critical buckling force is modified, as previously explained.

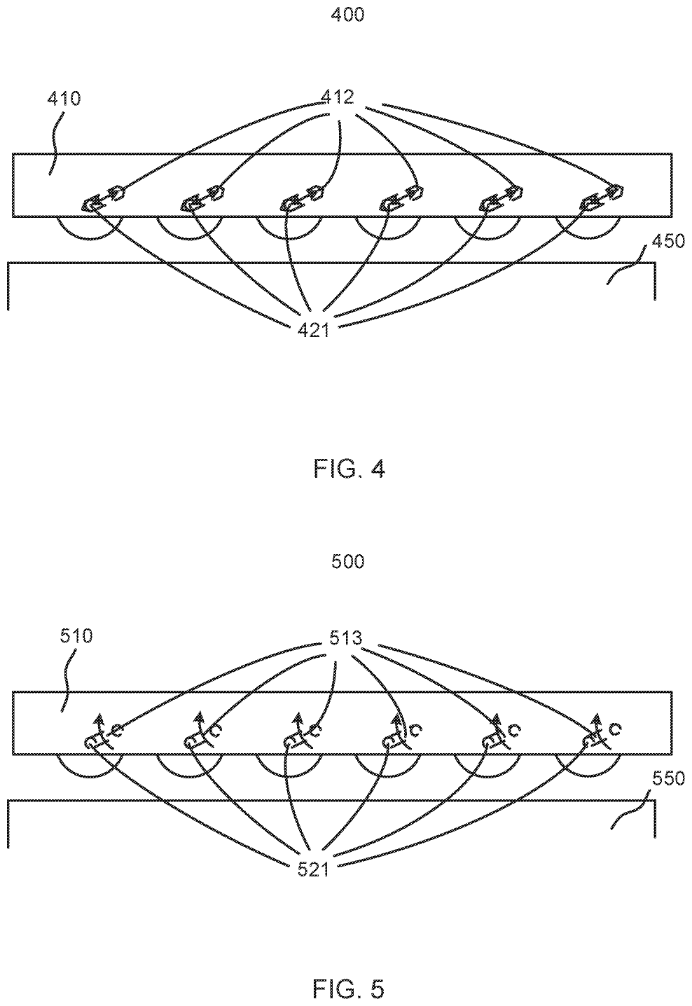

Referring now to FIG. 4, a side view of a roller assembly 400 comprising a plurality of guiding tracks 412 to enable movement of the rollers with respect to a target surface 450 is shown. The roller assembly 400 comprises a fixed frame 410, a plurality of rollers that protrude from a bottom surface of the fixed frame 410, and a coupling member (not shown in FIG. 4) to couple the fixed frame 410 to a reference surface. To enable the movement of each of the rollers with respect to the bottom surface of the fixed frame 410, the fixed frame 410 comprises the plurality of guiding tracks 412. In particular, each guiding track of the plurality of guiding tracks 412 is to receive a respective pin of a plurality of pins 421. As a result, each pin of the plurality of pins 421 is movable within a respective guiding track of the plurality of guiding tracks 412 such that contact between the rollers and a medium moving over the target surface 450 will cause a roller to move along a guiding track.

Although the guiding tracks of the plurality of guiding tracks 412 of the roller assembly 400 enable a movement of the plurality of guiding pins 421 both vertically and horizontally, in other examples the guiding tracks may correspond to a plurality of vertical guiding tracks.

Referring now to FIG. 5, a side view of a roller assembly 500 comprising a plurality of pivoting arms 513 to enable movement of the rollers with respect to a bottom surface of a fixed frame 510 is shown. As a result, the plurality of rollers of the roller assembly 500 is to contact an upper surface of a medium having a thickness within a range of media thicknesses. The roller assembly 500 of FIG. 5 comprises a fixed frame 510, the plurality of rollers, and a coupling member (not shown in FIG. 5). The plurality of rollers is positioned at a distance above a target surface 550 such that a gap is provided between the fixed frame 510 and the target surface 550.

To rotatably couple the plurality of rollers to the fixed frame 510, the fixed frame 510 comprises the plurality of pivoting arms 513. For each pivoting arm of the plurality of pivoting arms 513, a first end is coupled to the fixed frame 510 and a second end is coupled to a pin of a plurality of pins 521. As a result, the plurality of rollers is movable with respect to the bottom surface of the fixed frame 510 and the target surface 550. In some examples, each pivoting arm is rotatable between a lowermost position corresponding to a minimum admissible thickness for a medium (for instance, a thickness of 0.1 mm) and an uppermost position corresponding to a maximum admissible thickness for a medium (for instance, a thickness of 2 mm, 3 mm, or 4 mm). In an example, each pivoting arm has a movement range to enable the plurality of parallel rollers to move with respect to the bottom surface of the fixed frame 510 within a distance range from 1 mm to 9 mm.

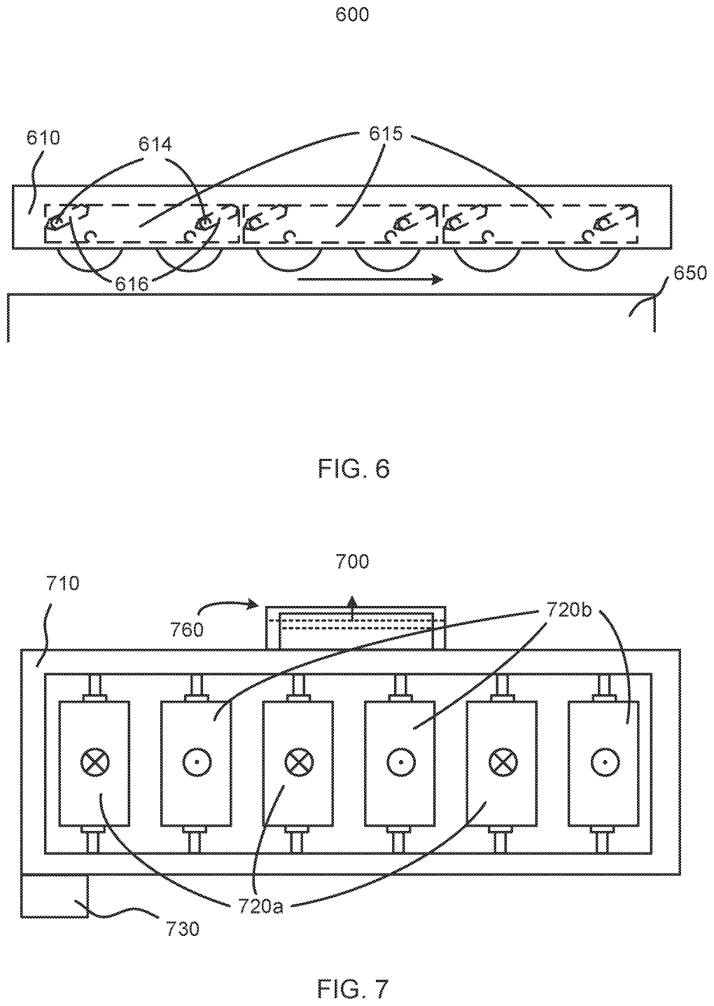

Referring now to FIG. 6, a side view of a roller assembly 600 comprising a plurality of floating frames 615 is shown. The roller assembly 600 comprises a fixed frame 610, a plurality of floating frames 615 comprising a plurality of parallel rollers, and a coupling member (not shown in FIG. 6). The fixed frame 610 comprises guiding tracks 614 to enable movement of the plurality of floating frames 615 (and hence, movement of the plurality of rollers) with respect to a target surface 650 and a bottom surface of the fixed frame 610. To couple the plurality of floating frames 615 to the fixed frame 610 of the roller assembly 600, each floating frame of the plurality of frames 615 comprises guiding pins 616 movable within respective guiding tracks. In addition, to enable movement of the plurality of rollers with respect to the bottom surface of the fixed frame 610, the plurality of floating frames 615 comprises a plurality of guiding axis coupled to the plurality of rollers.

Since the plurality of rollers of the roller assembly 600 is distributed along the plurality of floating frames 615, a contact of a medium with a roller belonging to one of the plurality of floating frames 615 will result in an upwards movement of the respective floating frame. For instance, if a medium contacts the first roller, the first floating frame will move upwards, thereby causing the second roller to move upwards as well. In this fashion, damages caused by an impact of the rollers with a leading edge of the medium moving between the fixed frame 610 and the target surface 650 will be reduced while still preventing media buckling events. In addition, the use of floating frames enables to increase the force towards an upper surface of the medium (because of the weight of the floating frames).

Although in FIG. 6 each floating frame of the plurality of floating frames 615 of the roller assembly 600 comprises two rollers, in other examples the floating frames may comprise a different number of rollers instead of two.

As previously explained, a medium will experience media buckling when the forces transmitted by the plurality of rollers to the medium exceed a critical buckling force. The forces transmitted to the medium include, among others, the frictional forces generated during the contact between the medium and the rollers.

The frictional forces, which oppose the motion of the medium, appear when the medium contacts the rollers. Frictional force may comprise the rolling friction generated when the rollers roll over the medium, the rolling friction being a function of a friction coefficient (based on the materials of the roller and the medium) and a normal force that the rollers transmit to the upper surface of the medium.

Referring now to FIG. 7, a top view of a roller assembly 700 comprising a locking member 760 is shown. The roller assembly 700 comprises a fixed frame 710, a plurality of rollers, a coupling member 730 to mechanically couple the fixed frame 710 to a reference surface, and the locking member 760. The plurality of rollers of the roller assembly 700 protrudes from a bottom surface of the fixed frame 710 and is movable within a distance range with respect to the bottom surface of the fixed frame 710. In this fashion, the rollers are capable of contacting media having a thickness within a thickness range associated with the distance range without experiencing media buckling.

The forces exerted towards the upper surface of the medium by the rollers may cause the medium to buckle. To reduce the transmitted forces, the locking member 760 of the roller assembly 700 keeps some of the rollers away from the medium. In FIG. 7, the locking member 760 is movable between a locking position in which the locking member 760 locks a first group of rollers 720a in an upper position and an unlocking position in which the locking member unlocks the first group of rollers 720a from the upper position. As a result, in the locking position of the locking member 760, the rollers are away from the medium. Hence, in case of having a medium moving beneath the fixed frame 710 of the roller assembly 700, the medium will pass beneath the first group of rollers 720a without contacting them and the medium will contact a second group of rollers 720b which is in a lower position. In this fashion, the overall frictional forces transmitted to the medium will be reduced and the range of thickness in which the roller assembly 700 prevents the medium from media buckling may be increased.

Since the properties of the medium which have an impact on media buckling cannot be modified when performing a media loading operation, the roller assembly 700 controls the external loads applied to the medium. In the present case, the external loads applied to the medium are controlled by locking some of the rollers away from the medium. Hence, as a result, the thickness range in which the medium will not experience media buckling is greater compared to the roller assemblies 100, 200, 300, 400, 500, and 600 previously explained in reference to FIGS. 1 to 6 (in which the roller assemblies cannot keep some of the rollers away from the medium). For instance, in an example, the criteria to use the locking member 760 to lock some of the rollers may be the type of media being loaded. Therefore, when loading a medium in which the contact results in a high friction coefficient between the rollers and the medium, some of the rollers may be locked in an upper position so as to reduce the forces received by the medium (and hence, reduce the chances of experiencing media buckling.

In an example, to lock the rollers in the lock the first group of rollers 720a in the upper position, the locking member 760 may be mechanically connected to a plurality of locking elements capable of moving the rollers towards the fixed frame 710. In an example, the locking elements may be in the form of locking protruding elements to protrude from an inner surface of the fixed frame 710 when the locking member 760 is in the locking position. Once the protruding locking elements have protruded from the fixed frame 710, the protruding locking elements keep the rollers to the upper position in which the rollers are away from the medium and the target surface.

In other examples, the locking member 760 of the roller assembly 700 may be capable of selectively locking the plurality of parallel rollers in an upper position away from the medium. In this fashion, a user of the roller assembly 700 may select a number of rollers of the plurality of parallel rollers to be locked in the upper position. In an example, the locking member 760 may comprise a plurality of locking members corresponding to the plurality of parallel rollers to selectively lock the plurality of parallel rollers.

Although the locking member 760 of the roller assembly 700 of FIG. 7 is in the form of a handle coupled to the fixed frame 710 of the roller assembly 700, alternative locations and forms may be possible. Similarly, the locking member 760 may comprise further positions besides of the locking position and the unlocking position to further control the loads transmitted towards the medium.

According to an example, a roller assembly may comprise a plurality of rollers having a diameter within a diameter range from 20 mm to 34 mm, a length within a length range from 35 mm to 55 mm, and a weight within a weight range from 80 grams to 120 grams. In an example, when having a number of rollers within a range from 8 to 15, the roller assembly may be capable of preventing media buckling within a thickness range from 0.1 mm to 3.5 mm. However, depending on the type of media, the roller assembly may be capable of preventing media buckling within a thickness range from 0.1 to 5 mm.

According to some examples, a media loading system may comprise a conveyor to move a medium towards an output region, a lateral guide extending along a length of the conveyor and adjacent to the conveyor, and a roller assembly extending along a length of the conveyor. The roller assembly may correspond to the roller assemblies previously explained in reference to FIGS. 1 to 7.

As previously explained, the plurality of rollers represented in the roller assemblies of FIGS. 1 to 7 is movable between a lowermost position in which the rollers are away from the fixed frame of the roller assembly and an uppermost position in which the rollers are away from the target surface. In an example, the lowermost position corresponds to a position in which the rollers contact the target surface.

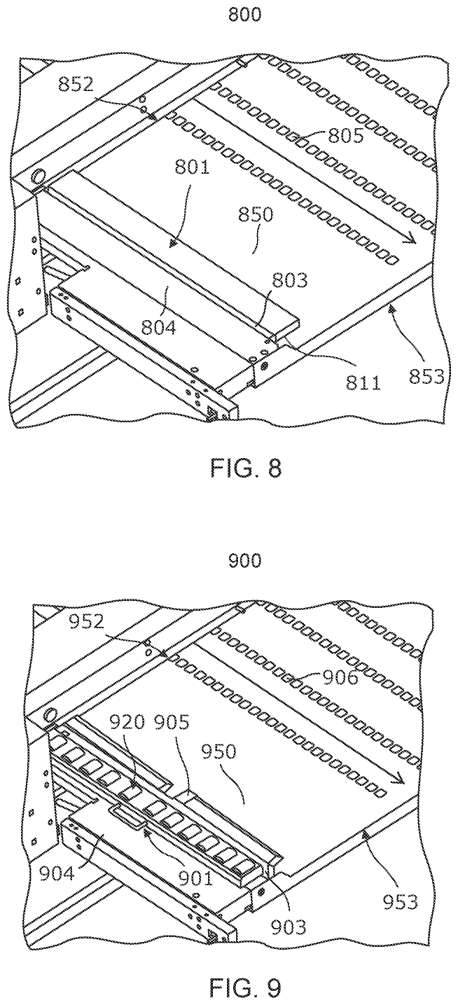

Referring now to FIG. 8, a media loading system 800 comprising a roller assembly 801 for preventing media buckling is shown. The media loading system 800 comprises a conveyor 805 to move the medium towards an output region 853, a lateral guide 804 extending along the length of the conveyor 805 and adjacent to the conveyor 805, and the roller assembly 801 coupled to the lateral guide 804 via a coupling member 803. The media loading system 800 is to receive a medium an input region 852. The roller assembly 801 comprises a plurality of rollers rotatable about a plurality of guiding axis perpendicular to the lateral guide 804. As previously described, the plurality of rollers of the roller assembly 801 protrudes from a bottom surface 811 of the roller assembly 801.

Upon receiving a medium in the input region 852 of a platen 850, the conveyor 805 is to move the medium to the output region 853. During the movement towards the output region 853, the medium advances through a gap defined between the bottom surface 811 of the roller assembly 801 and the platen 850. Then, the medium will contact rollers of the plurality of rollers distributed along the roller assembly 801. As previously explained, the plurality of rollers is movable with respect to a target surface (in FIG. 8 the target surface corresponds to the plate 850) to contact an upper surface of the medium as the medium is moved by the conveyor 805 towards the output region 853. In particular, each roller is movable between a first position in which the roller is away from the bottom surface 811 of the roller assembly 801 and a second position in which the roller is away from the platen 850. A distance range defined from the first position and the second position may be associated with a range of media thicknesses admitted by the roller assembly.

In an example, the roller assembly 801 may prevent media from buckling within a range of media thickness from 0.1 mm to 2 mm. In other examples, the roller assembly 801 may prevent media from buckling for media having an area density within a range from 80 grams per square meter to 1000 grams per square meter. In some other examples, for other types of media, the range of media thickness may comprise thicknesses from 0.1 mm to 3.5 mm. In further examples, the plurality of rollers of the roller assembly 801 is movable within a distance range associated with a media thickness from 0.1 mm to 4 mm.

In use, the media loading system 800 transports a medium towards the output region 853. While moving, the medium may contact the lateral guide 804 of the media loading system 800. In an example, the conveyor 805 may move the medium towards the output region 853 in a direction tilted towards the lateral guide 804 (for instance, 1.5 degrees, 2.5 degrees, or an angle within a range from 0.5 to 3 degrees) to cause the medium to contact with the lateral guide 804. In other examples, the lateral guide 804 may comprise a skew with respect to the direction in which the conveyor 805 is to move the medium over the platen 850.

In FIG. 8, the roller assembly 801 is adjacent to the lateral guide 804 of the media loading system 800. In particular, the plurality of rollers of the roller assembly 801 is aligned along the roller assembly 801 at a distance with respect to the lateral guide 804. As previously explained, the unsupported length of the medium may have an impact on the appearance of the media buckling (for instance, media buckling may appear after an edge of the medium contacts the lateral guide 804 of the media loading system 800). Hence, to increase the critical buckling force, the unsupported length of the medium is decreased. In an example, a distance between the plurality of rollers of the roller assembly and the lateral guide 804 is lower than 2 mm. In other examples, the distance may be lower than 1 mm. Nonetheless, when other elements of the media loading system 800 are positioned between the plurality of rollers and the lateral guide 804, the plurality of rollers of the roller assembly 801 may be positioned as close as possible to the lateral guide 804.

Although the conveyor 805 of the media loading system 800 of FIG. 8 corresponds to a series of rollers protruding from the platen 850, alternative conveyors may be possible. In an example, the conveyor may correspond to a belt extending along a length of the platen. In some other examples, the conveyor may correspond to a belt oriented towards the lateral guide 804 of the media loading system 800. Similarly, in other examples, the platen 850 may comprise a plurality of idle rollers protruding from the platen to reduce the friction forces between the platen 850 and the medium moving over the platen 850.

Referring now to FIG. 9, a media loading system 900 comprising a roller assembly 901 in a non-operative position is shown. In the non-operative position, a plurality of rollers 920 of the roller assembly 901 is positioned away from a platen 950 of the media loading system 900 (i.e., the plurality of rollers 920 is not capable of contacting a medium moving over the platen 950). To enable the movement from an operative position (in which the plurality of rollers 920 is positioned to contact a medium) to the non-operative position (in which the plurality of rollers 920 is away from the platen 950), a coupling member 903 comprising a hinge is to rotatably couple the roller assembly to a lateral guide 904 of the media loading system 900.

In use, the media loading system 900 is to move a medium from an input region 952 to an output region 953. To transport the medium, the media loading system comprises a conveyor 905. In some examples, the conveyor 905 may be tilted towards the lateral guide 904 at an angle within a range from 0.5 to 3 degrees. In this fashion, the conveyor 905 transports the medium towards the output region 953 at the same time that the medium is being brought into contact with the lateral guide 904. In other examples, the medium loaded in the input region 952 of the media loading system 900 may be skewed and a movement of the medium along the platen 950 may result in a contact between the medium and the lateral guide 904 of the media loading system 900.

In FIG. 9, the platen 950 of the media loading system 900 further comprises a series of idle rollers 906 protruding from the platen 950 to reduce the frictional forces generated from contact between the medium and the platen 950. However, in other examples, the platen 950 may not comprise the series of idle rollers 906.

In some examples, the roller assemblies of the media loading systems 800 and 900 may correspond to the roller assemblies previously explained in reference to FIGS. 1 to 7. In an example, the media loading systems 800 and 900 may comprise the roller assembly 600 (i.e., the plurality of rollers may be distributed in a plurality of floating frames movably coupled to the fixed frame of the rolling assembly). In other examples, the media loading systems 800 and 900 may comprise the roller assembly 500 (i.e., each roller of the plurality of rollers movably coupled to the fixed frame of the rolling assembly via a respective pivoting arm). In some other examples, the media loading systems 800 and 900 may comprise the rolling assemblies 200, 300, and 400 to enable movement of the rollers with respect to the target surface (i.e., the platens 850 and 950 of the media loading systems 800 and 900). Similarly, in some other examples, the media loading systems 800 and 900 may comprise the rolling assembly 600 to lock some of the rollers in an upper position away from the medium.

Although in the rolling assemblies 100, 200, 300, 400, 500, 600, and 700 and the media loading systems 800 and 900, the elements used to contact an upper surface of the medium correspond to rollers, in other examples alternative rolling elements may be used. Examples of rolling elements comprise idle rolling balls, idle wheels, idle belts, among others. However, it should be noted that the use of rollers enables further reduction of the unsupported length of a medium with respect to alternative solutions such as rolling balls.

According to some other examples, a media loading system may comprise a conveyor to move a medium towards an output region, a lateral guide adjacent to the conveyor, and a media buckling prevention mechanism comprising an upper frame extending along a length of a reference surface, the upper frame being positioned at a distance above a platen of the media loading system. To enable media buckling prevention, the media loading buckling prevention mechanism further comprises a plurality of rolling elements protruding from a bottom surface of the upper frame, wherein the rolling elements are to contact an upper surface of the medium. To prevent the medium from buckling while moving towards the output region, the plurality of rolling elements is biased towards the medium so that a contact of a rolling element with the upper surface of the medium pushes the rolling elements towards the upper frame. Instead of being mechanically coupled to a reference surface (for instance, a lateral guide of the media loading system, the media loading buckling prevention mechanism may be located at any location along the width of the platen of the media loading system. In this fashion, the media loading buckling prevention mechanism reduces the unsupported length of the medium thereby preventing the medium from buckling.

According to some other examples, the upper frame of the media loading buckling prevention mechanism may comprise a locking member to selectively lock at least one of the rolling elements in a position away from the medium such that an overall force extorted towards the upper surface of the medium is reduced.

In some additional examples, the upper frame of the media loading buckling prevention mechanism may further comprise biasing members to bias the rolling elements towards the upper surface of the medium such that an overall force exerted towards the medium is increased.

What has been described and illustrated herein are examples of the disclosure along with some variations. The terms, descriptions, and figures used herein are set forth by way of illustration only and are not meant as limitations. Many variations are possible within the scope of the disclosure, which is intended to be defined by the following claims (and their equivalents) in which all terms are meant in their broadest reasonable sense unless otherwise indicated.

What is claimed is:

1. A roller assembly for media loading comprising:
a fixed frame;
a plurality of parallel rollers that protrude from a bottom surface of the fixed frame, wherein each roller is rotatably coupled to the fixed frame via a respective pin; and
a coupling member to mechanically couple the fixed frame to a reference surface,
wherein the plurality of parallel rollers is movable with respect to the bottom surface of the fixed frame.

2. The roller assembly of claim 1, wherein the coupling member comprises a hinge to enable a rotation of the fixed frame with respect to the reference surface.

3. The roller assembly of claim 1, further comprising a locking member to selectively lock the plurality of parallel rollers in an upper position away from the medium.

4. The roller assembly of claim 1, wherein the fixed frame further comprises a plurality of pivoting arms, wherein each pivoting arm has a first end coupled to the fixed frame and a second end coupled to a pin of the plurality of pins.

5. The roller assembly of claim 4, wherein the plurality of parallel rollers is movable with respect to the bottom surface of the fixed frame within a distance range from 1 mm to 9 mm.

6. A media loading system comprising:
a conveyor to move a medium towards an output region;
a lateral guide adjacent to the conveyor, wherein the lateral guide extends along a length of the conveyor; and
a roller assembly extending along the length of the conveyor, the roller assembly comprising:
a plurality of rollers rotatable about a plurality of guiding axis perpendicular to the lateral guide, wherein the plurality of rollers is movable with respect to the conveyor to contact an upper surface of the medium as the medium is moved by the conveyor towards the output region.

7. The media loading system of claim 6, wherein the plurality of rollers is aligned along the roller assembly at a distance with respect to the lateral guide, the distance being lower than 2 mm.

8. The media loading system of claim 6, wherein the plurality of rollers is movable within a distance range associated with a media thickness from 0.1 mm to 4 mm.

9. The media loading system of claim 6, wherein the roller assembly further comprises:
a fixed frame comprising guiding tracks; and
a plurality of floating frames, the plurality of floating frames comprising:
guiding pins movable within the guiding tracks, and
the plurality guiding axis coupled to the plurality of rollers.

10. The media loading system of claim 6, wherein the roller assembly further comprises:
a fixed frame; and
a plurality of pivoting arms, each pivoting arm comprising:
a first end rotatably coupled to the fixed frame, and
a second end coupled to a roller via a respective guiding axis.

11. The media handling system of claim 10, wherein media loading system further comprises a hinge to enable a rotation of the roller assembly with respect to the lateral guide, wherein the roller assembly is movable between an operative position in which the plurality of rollers faces the conveyor and a non-operative position in which the plurality of rollers is away from the conveyor.

12. A media loading buckling prevention mechanism comprising:
an upper frame extending along a length of a reference surface, wherein the upper frame is to be positioned at a distance above a target surface; and
a plurality of rolling elements protruding from a bottom surface of the upper frame, wherein the plurality of rolling elements is movable to contact an upper surface of the medium to be moved over the target surface,
wherein the plurality of rolling elements is biased towards the medium so that a contact of a rolling element with the upper surface of the medium pushes the rolling element towards the upper frame.

13. The media loading buckling prevention mechanism of claim 12, wherein the upper frame further comprises a locking member to selectively lock at least one of the rolling elements in a position away from the medium such that an overall force exerted towards the upper surface of the medium is reduced.

14. The media loading buckling prevention mechanism of claim 12, wherein the upper frame further comprises biasing members to bias the rolling elements towards the upper surface of the medium such that an overall force exerted towards the upper surface of the medium is increased.

15. The media loading buckling prevention mechanism of claim 12, wherein each rolling element is to exert to the medium a force within a range from 0.8 N to 1.2 N.
